(19) United States
(12) Patent Application Publication
(10) Pub. No.: US 2010/0306056 A1
(43) Pub. Date: Dec. 2, 2010

(54) SYSTEM AND METHOD OF REMOTE MACHINE SERVICING

(75) Inventor: James Michael Rego, Webster, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/474,048

(22) Filed: May 28, 2009

(51) Int. Cl. G06Q 30/00; G06F 15/00

(52) U.S. Cl. 705/14.55; 358/1.15

(57) ABSTRACT

A system for servicing a printing system includes a first device and a processor in communication with a storage medium. The system receives a first request to service the first device, determines a first number of carbon credits associated with driving a vehicle to a location of the first device, receives a second request to service a second printing device having a second number of carbon credits, offers a selected number of carbon credits to a customer to incent acceptance of remote repair of the first device, and causes remote service to be performed relative to the first device upon an acceptance of the offer. The selected number of carbon credits may be greater than the first number of carbon credits and, at least in part, to the first and second numbers of carbon credits.

### BACKGROUND

1. Technical Field

This application relates to servicing and repairing machines, such as printers and more particularly to a method in which a customer is provided incentive for servicing machines remotely.

2. Description of Related Prior Art

Diagnosis and repair of complex electromechanical devices requires sophisticated techniques and highly trained service engineers. Conventionally, service engineers travel to a customer site in order to perform repairs as a result of a customer call. Current on-site service processes for diagnosis and repair of electromechanical devices can include significant device downtime, which results in reduced productivity. After requesting an engineer, the customer waits for the engineer's arrival which increases downtime of the device and interrupts the associated workflow. Once on site, the engineer uses a repair analysis procedure that is typically a set of computationally coded steps that the service engineer executes. A step or test could include, for example, a request for information, a diagnostic routine or an electrical or visual check on the device. The service engineer is directed to one of a plurality of steps in the repair analysis procedure depending on the outcome of each test. The process is repeated after the next step until a conclusion is reached.

Alternatively, remote servicing can be performed. Methods of remote repair for printing systems have been known in the art. For example, U.S. Pat. No. 5,615,015 to Krist et al. is incorporated by reference herein in its entirety to further describe an example of an exemplary printing system. A remote repair operation enables an immediate response to a customer call. A service center receives a request for the repair of an electromechanical device. The request identifies the malfunctioning device and a fault code identifying a specific malfunction. A repair analysis procedure is automatically deployed and performed from the service center by a service engineer and/or an automated repair program. The repair analysis-procedure directs execution of a computationally coded sequence of steps. The repair analysis procedure might direct the engineer or repair program to request additional information, follow a diagnostic routine from the service center, and/or conduct an electrical check on the device. A subsequent step is then initiated based on the received response. The process is repeated until a conclusion is reached. Such remote repair can save time and environmental resources, especially within a carbon credit market.

Global awareness has led to the creation of carbon credit markets along with international discussion of such markets. A carbon credit market is a market which attempts to offset carbon and equivalent emissions sent into the atmosphere through investment opportunities. Entities are offered the chance to invest in projects that will reduce such emissions. In return, these entities can receive carbon credits issued by the project leaders or another appointed organization. These carbon credits are typically independently verified by a designated third party. The designated third party also monitors the difference between baseline and actual emissions to ensure appropriate amounts of carbon credits are issued.

In some cases, an entity could be required to acquire a specified number of carbon credits. This requirement could result from either voluntary or regulatory carbon credit market systems. Entities, such as large corporations, are interested in new ways to amass carbon credits and participate in a global commitment to reduce carbon and equivalent emissions.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “machine” is a reference to one or more machines and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a service system for servicing a printing system may include a processor, a first printing device, and a computer-readable storage medium in communication with the processor. The computer-readable storage medium may include one or more programming instructions for receiving a first request to service the first printing device, determining a first number of carbon credits associated with driving a vehicle from a service center to a location of the first printing device, receiving a second request to service a second printing device, offering a selected number of carbon credits to a customer to incent acceptance of remote repair of the first printing device based at least in part on the determining, and causing remote service to be performed relative to the first printing device responsive to receiving an acceptance of the offer of the selected number of carbon credits so that the vehicle need not be driven from the service center to the location of the first printing device. A second number of carbon credits may be associated with the second request. The selected number of carbon credits may be greater than the first number of carbon credits and may correspond, at least in part, to the first and second numbers of carbon credits.

In an embodiment, a system for providing an incentive to remotely service a printing device may include a processor, an output device in communication with the processor, and a computer-readable storage medium in communication with the processor. The computer-readable storage medium may include one or more programming instructions for receiving a first request to service a first printing device via a remote repair operation, remotely servicing the first printing device, receiving a second request to service at least one second printing device, determining an offered number of accumulated carbon credits comprising a sum of at least a first number of carbon credits associated with the first request and a second number of accumulated carbon credits associated with the second request, offering the offered number of accumulated carbon credits to a customer to incent acceptance of remote repair of the second printing device, receiving an acceptance of the offered number of accumulated carbon credits, providing the offered number of accumulated carbon credits to the customer, and issuing a command to remotely service the second printing device.

In an embodiment a method of servicing a printing device may include receiving a first request to service a first printing device via a remote repair operation, remotely servicing the first printing device, receiving a second request to service at least one second printing device, automatically determining through a processor an offered number of accumulated carbon credits comprising a sum of at least a first number of carbon credits associated with the first request and a second number of accumulated carbon credits associated with the second request, offering the offered number of accumulated carbon credits to a customer to incent acceptance of remote repair of the second printing device, and remotely servicing the second printing device.

### BRIEF DESCRIPTION OF THE DRAWINGS

Aspects, features, benefits and advantages of the present application will be apparent with regard to the following description and accompanying drawings, of which:

FIG. 1 depicts a flow diagram of an exemplary method of incentivizing remote servicing of a machine according to an embodiment.

FIG. 2 is a block diagram of exemplary internal hardware that may be used to contain or implement program instructions according to an embodiment.

FIG. 3 is a block diagram of an exemplary printing system connected via a network to the exemplary internal hardware of FIG. 2.

FIG. 4 depicts a flow diagram of another exemplary method of incentivizing remote servicing of a printing device according to an embodiment.

### DETAILED DESCRIPTION

The following term shall have, for the purposes of this application, the meaning set forth below.

A “machine” refers to a mechanical instrument configured to provide a desired function. For example, a machine may provide a printing function. A machine may additionally or alternatively provide a copying function. A machine, for example, may be a printer, copier, fax, multi-function device and/or the like. Additional machine types may also be included within the scope of this disclosure.

A “printing device” is an electronic device that is capable of receiving commands and printing text and/or images on a substrate and/or scanning a document. Printing devices may include, but are not limited to, network printers, production printers, copiers, facsimile devices, other devices using ink or toner, and scanners. Printing devices may also perform a combination of functions such as printing/scanning/copying/faxing, in which case such devices may be considered to be multifunctional devices.

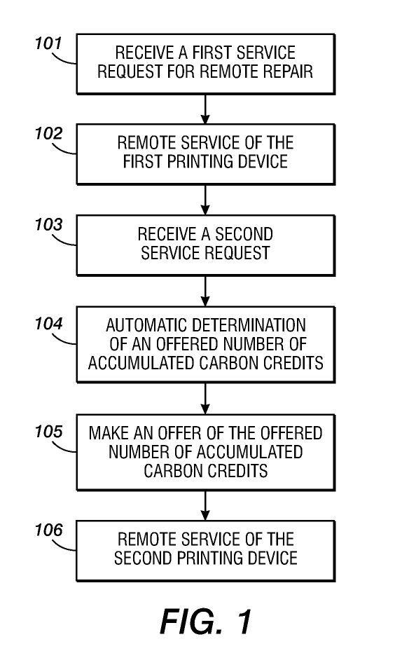

According to an embodiment, FIG. 1 depicts a flow diagram of an exemplary method of incentivizing remote servicing of a printing device. As shown in FIG. 1, a first request to service a first printing device by performing a remote repair operation may be received 101. In an embodiment, the first request to service the machine may be received 101 from the customer. For example, the customer may contact a service center directly via an electronic device or a telecommunication device. Additional and alternate forms of communication may also be applicable.

In an alternative embodiment, the first service request may be initiated by the printing device itself. For example, the machine may be connected to the internet and may communicate with a system operated in conjunction with a service center. Alternatively, the machine may communicate with a system or a service center via other electronic, infrared, or telecommunication devices. The machine may further associate an error condition with an identification code such as a fault code which is provided to, for example, service engineer personnel. The first printing device may be remotely serviced 102.

A second request to service at least one second printing device may be received 103. Exemplary forms of communication for receiving 103 the second service request may include those described above with respect to the first service request. A processor may automatically determine 104 an offered number of accumulated carbon credits. The offered number of accumulated carbon credits may equal the sum of at least a first number of carbon credits associated with the first request and a second number of accumulated carbon credits associated with the second request.

The offered number of accumulated carbon credits may be offered 105 to a customer to incent acceptance of remote repair for the second printing device. The offer may be made via an electronic device or a telecommunication device, such as through an e-mail, a fax, or a phone call. Other methods of offering 105 some or all of the accumulated carbon credits may be performed within the scope of this disclosure.

The customer operating a second printing device may desire carbon credits for regulatory or voluntary reasons whereas the customer operating a first printing device may not have such a desire or need for carbon credits. An additional amount of carbon credits beyond those associated with driving a vehicle from a service center to the location of the second printing device may be offered from the accumulated carbon credits. This additional amount may meet a threshold level required or requested by the customer with the second service request in order to accept remote repair of the second printing device. The second printing device may then be remotely serviced 106.

In another embodiment, a first request to service one or more first printing devices of a printing system may be received. A second request to service a second printing device may be received. A number of carbon credits may be associated with the second request.

A number of carbon credits associated with driving a vehicle from a service center to a location of the one or more first printing devices may be determined. Based at least in part on this determination, a selected number of carbon credits may be offered to a customer. The selected number of carbon credits may be greater than the determined number of carbon credits. The selected number of carbon credits may correspond, at least in part, to the carbon credits associated with both the first service request and the second service request.

The selected number of carbon credits is offered to incent acceptance of remote repair of the one or more first printing devices. Responsive to receiving an acceptance of the offer, remote service may be performed relative to the one or more first printing devices. Remote service does not require a vehicle to be driven from the service center to the location for servicing of the one or more first printing devices. In an embodiment, responsive to receiving a rejection of the offer, local service may be performed relative to the one or more first printing devices.

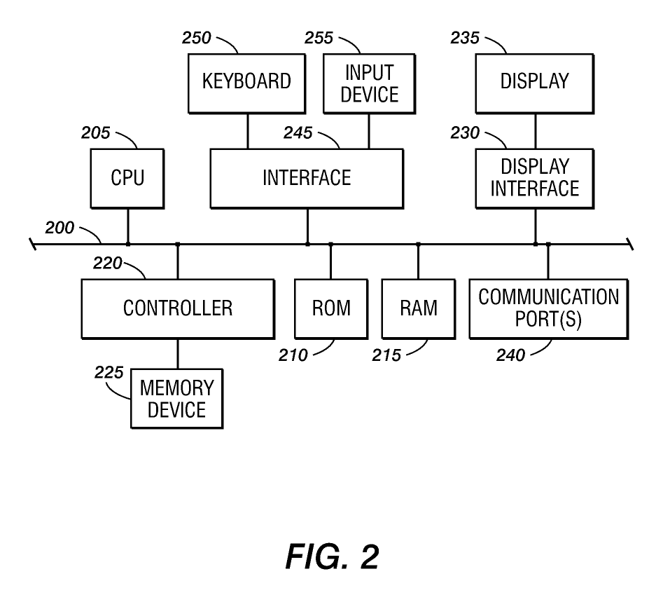

FIG. 2 depicts a block diagram of exemplary internal hardware that may be used to contain or implement program instructions according to an embodiment. A bus 200 serves as the main information highway interconnecting the other illustrated components of the hardware. CPU 205 is the central processing unit of the system, performing calculations and logic operations required to execute a program. Read only memory (ROM) 210 and random access memory (RAM) 215 constitute exemplary memory devices.

A controller 220 interfaces with one or more optional memory devices 225 to the system bus 200. These memory devices 225 may include, for example, an external or internal DVD drive, a CD ROM drive, a hard drive, flash memory, a USB drive or the like. As indicated previously, these various drives and controllers are optional devices.

Program instructions may be stored in the ROM 210 and/or the RAM 215. Optionally, program instructions may be stored on a tangible computer readable medium such as a compact disk, a digital disk, flash memory, a memory card, a USB drive, an optical disc storage medium, such as Blu-ray™ disc, and/or other recording medium.

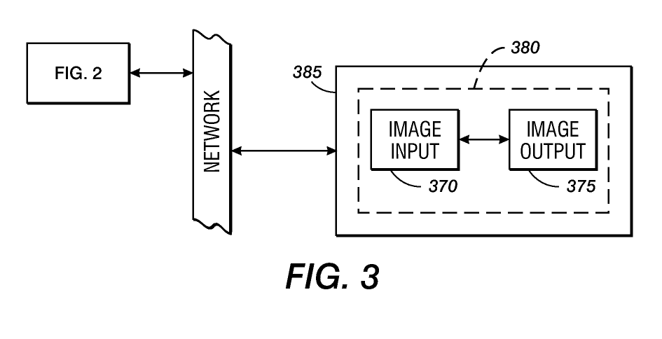

FIG. 3 depicts a block diagram of an exemplary printing system 385 connected via a network to the exemplary internal hardware of FIG. 2. Referring to FIG. 3, the one or more first printing devices may include one of an image input device 370 and an image output device 375. The image input device 370 and an image output device 375 may combine to provide a copier or copy process 380.

An optional display interface 230 may permit information from the bus 200 to be displayed on the display 235 in audio, visual, graphic or alphanumeric format. Communication with external devices may occur using various communication ports 240. An exemplary communication port 240 may be attached to a communications network, such as the Internet or an intranet.

The hardware may also include an interface 245 which allows for receipt of data from input devices such as a keyboard 250 or other input device 255 such as a mouse, a joystick, a touch screen, a remote control, a pointing device, a video input device and/or an audio input device.

An embedded system, such as a sub-system within a xerographic apparatus, may optionally be used to perform one, some or all of the operations described herein. Likewise, a multiprocessor system may optionally be used to perform one, some or all of the operations described herein.

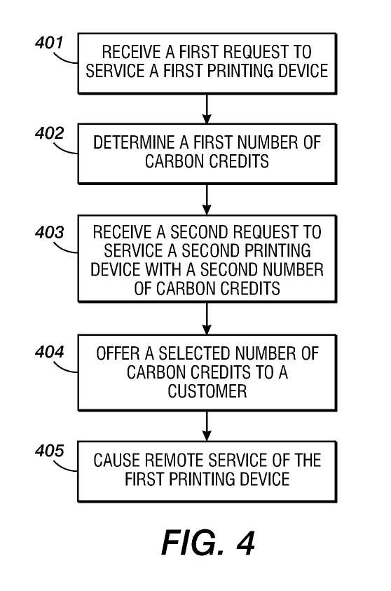

According to an embodiment, FIG. 4 depicts a flow diagram of another exemplary method of incentivizing remote servicing of a printing device. As shown in FIG. 4, a request to service a first printing device may be received 401. In an embodiment, the request to service the first printing device may be received 401 from the customer. The customer may contact a service center directly via, for example, an electronic device or a telecommunication device. In an alternate embodiment, the request to service the first printing device may be initiated by the first printing device itself For example, the first printing device may be connected to the internet and may communicate with a system operated in conjunction with a service center. Alternatively, the first printing device may communicate with a system or a service center via other electronic, infrared, or telecommunication devices. The first printing device may further associate an error condition with an identification code such as a fault code which is provided to, for example, service engineer personnel.

A first number of carbon credits associated with driving a vehicle from a service center to a location of the first printing device may be determined 402. The first number of carbon credits may be determined 402, for example, based on a distance from the service center to the location of the first printing device and an average fuel consumption of a vehicle operated by the service center. The distance and fuel consumption may be factors in a calculation to determine 402 the first number of carbon credits.

A second request to service a second printing device may be received 403. For example, the customer may contact a service center directly via an electronic device or a telecommunication device. Additional and alternate forms of communication may also be applicable. In an alternate embodiment, the request to service the second printing device may be initiated by the second printing device itself. For example, the second printing device may be connected to the internet and may communicate with a system operated in conjunction with a service center. Alternatively, the second printing device may communicate with a system or a service center via other electronic, infrared, or telecommunication devices. The second printing device may further associate an error condition with an identification code such as a fault code which is provided to, for example, service engineer personnel. A second number of carbon credits may be associated with the second request.

A selected number of carbon credits may be offered 404 to a customer to incent acceptance of remote repair of the first printing device. The selected number of carbon credits may be offered 404 based at least in part on the determining 402. The selected number of carbon credits may be greater than the determined number of carbon credits and may correspond, at least in part, to the carbon credits associated with both the first request and the second request. The offer may be made via an electronic device or a telecommunication device, such as through an e-mail, a fax, or a phone call. Other methods of offering 404 some or all of the accumulated carbon credits may be performed within the scope of this disclosure.

Remote service may be caused 405 to be performed relative to the first printing device responsive to receiving an acceptance of the offer 404 of the selected number of carbon credits so that the vehicle need not be driven from the service center to the location of the first printing device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A service system for servicing a printing system, comprising:
a processor;
a first printing device; and
a computer-readable storage medium in communication with the processor, the computer-readable storage medium including one or more programming instructions for:
receiving a first request to service the first printing device,
determining a first number of carbon credits associated with driving a vehicle from a service center to a location of the first printing device,
receiving a second request to service a second printing device, wherein a second number of carbon credits is associated with the second request,
based at least in part on the determining, offering a selected number of carbon credits to a customer to incent acceptance of remote repair of the first printing device, wherein the selected number of carbon credits is greater than the first number of carbon credits and the selected number of carbon credits corresponds, at least in part, to the first and second numbers of carbon credits, and
responsive to receiving an acceptance of the offer of the selected number of carbon credits, causing remote service to be performed relative to the first printing device so that the vehicle need not be driven from the service center to the location of the first printing device.

2. The service system of claim 1, wherein the computer-readable storage medium further includes one or more programming instructions for causing local service to be performed relative to the first printing device responsive to receiving a rejection of the offer of the selected number of carbon credits.

3. The service system of claim 1, wherein the first printing device comprises one of an image input device and an image output device.

4. The service system of claim 1, wherein the second printing device comprises one of an image input device and an image output device.

5. A system for providing an incentive to remotely service a printing device, comprising:
a processor;
an output device in communication with the processor; and
a computer-readable storage medium in communication with the processor,
wherein the computer-readable storage medium includes one or more programming instructions for:
receiving a first request to service a first printing device via a remote repair operation,
remotely servicing the first printing device,
receiving a second request to service at least one second printing device,
determining an offered number of accumulated carbon credits comprising a sum of at least a first number of carbon credits associated with the first request and a second number of accumulated carbon credits associated with the second request,
offering the offered number of accumulated carbon credits to a customer to incent acceptance of remote repair of the second printing device,
receiving an acceptance of the offered number of accumulated carbon credits,
providing the offered number of accumulated carbon credits to the customer, and
issuing a command to remotely service the second printing device.

6. The system of claim 5, wherein the first printing device comprises one of an image input device and an image output device.

7. The system of claim 5, wherein the second printing device comprises one of an image input device and an image output device.

8. The system of claim 5, wherein the first number of carbon credits comprises at least a portion of a total number of accumulated carbon credits associated with the first request.

9. The system of claim 5, wherein the second number of carbon credits comprises at least a portion of a total number of accumulated carbon credits associated with the second request.

10. A method of servicing a printing device, comprising:
receiving a first request to service a first printing device via a remote repair operation;
remotely servicing the first printing device;
receiving a second request to service at least one second printing device;
automatically determining, via a processor, an offered number of accumulated carbon credits comprising a sum of at least a first number of carbon credits associated with the first request and a second number of accumulated carbon credits associated with the second request;
offering the offered number of accumulated carbon credits to a customer to incent acceptance of remote repair of the second printing device; and
remotely servicing the second printing device.

11. The method of claim 10, wherein the first number of carbon credits comprises at least a portion of a total number of accumulated carbon credits associated with the first request.

12. The method of claim 10, wherein the second number of carbon credits comprises at least a portion of a total number of accumulated carbon credits associated with the second request.

13. The method of claim 10, wherein receiving the first request comprises receiving the first request from the customer.

14. The method of claim 10, wherein receiving the first request comprises receiving the first request from the first printing device.

15. The method of claim 10, wherein receiving the second request comprises receiving the second request from the customer.

16. The method of claim 10, wherein receiving the second request comprises receiving the second request from the second printing device.

17. The method of claim 10, further comprising:
offering an additional incentive not related to carbon credits to the customer.

18. The method of claim 17, further comprising:
providing the additional incentive to the customer.
